(19) United States
(12) Patent Application Publication
(10) Pub. No.: US 2024/0391739 A1
(43) Pub. Date: Nov. 28, 2024

(54) Grapple Assembly with Force Limiting Device and Method for Using

(71) Applicant: Paladin Brands Group, Inc., New Britain, CT (US)

(72) Inventors: Jay Koester, Manchester, IA (US); John Hageman, Dyersville, IA (US); Mark Oberfoell, Dyersville, IA (US)

(73) Assignee: Paladin Brands Group, Inc., New Britain, CT (US)

(21) Appl. No.: 18/321,217

(22) Filed: May 22, 2023

(51) Int. Cl. B66C 13/20; B66C 1/58; B66C 13/14

(52) U.S. Cl. CPC B66C 13/20; B66C 1/585; B66C 13/14

(57) ABSTRACT

A grapple assembly configured to be combined with a prime mover vehicle. The grapple assembly has a first tine configured to rotate relative to a second tine. The first tine is held in a first position by a force limiting device during normal operation. This force limiting device is movable between an operational position and a tripped position, and is biased in the operational position. The force limiting device has a pressure relief valve which opens to allow fluid to flow in a first direction when fluid pressure on the relief valve reaches a predetermined amount. The force limiting device is combined with the first tine so movement of the force limiting device from the operational position to the tripped position causes the first tine to rotate relative from the second tine thereby relieving forces generated by the prime mover's hydraulic system.

### BACKGROUND

Embodiments of the present disclosure generally relate to a grapple assembly. More particularly, embodiments of the present disclosure relate to a grapple assembly having a pressure relief mechanism.

Prime mover vehicles such as excavators, tractors, skid-steers, or other machines are configured for attachment to many different types of implements. Exemplary implements include grapples, buckets, clam shells, plows, fork lifts, bale spears, and the like. Prime mover vehicles typically include a pair of hydraulically actuated lifting arms or a boom assembly (collectively referred to herein as “arms”) for lifting and tilting the implements. A coupler may be used to connect the implements to the arms.

A grapple attachment is a type of implement having opposing tines configured to close together with a closing force to grab a load, such as a felled tree or a pile of brush. Some types of grapple attachments, generally referred to as powered grapples, include electric motors or hydraulic cylinders for actuating the tines between open and closed positions. The motors or cylinders of these grapple attachments are combined with and part of the grapple. Other types of grapple attachments, generally referred to as mechanical grapples, do not have independent motors or hydraulics to move the tines relative to each other. Instead, the opposing tines on these grapple attachments open and close by tilting the implement (using the tilt cylinders on the prime mover's arms) until the lower tine contacts the lifting arms of the prime mover and cannot rotate any further. The operator continues tilting the grapple attachment toward the arms causing the upper tine to rotate toward the lower tine until the two tines close around the load. An exemplary mechanical grapple is disclosed in U.S. patent application Ser. No. 17/858,546 filed on Jul. 7, 2022, the disclosure of which is hereby incorporated by this reference.

One problem with grapple assemblies is that in certain circumstances the closing force acting on one or both of the tines could increase to a level which could transmit a large compression force into the prime mover's arm and damage the arm. This could happen, for example, if the tines close around a dense load or if the tines are pressed against the ground or other unforgiving solid surface and excessive hydraulic force is applied to the loader's tilt cylinders. Typically, the prime mover's arms and associated hydraulics are not designed with intent for use with mechanical grapples, and therefore may not have sufficient structure to support the amount of hydraulic force capable of the loader's tilt cylinder circuit.

There is therefore a need for an improved grapple attachment which overcomes these and other drawbacks in the art.

### SUMMARY

One aspect of the present disclosure relates to a grapple assembly for grasping a load. The grapple assembly is configured to be combined with a prime mover vehicle by any suitable means. The grapple assembly has a first tine operatively combined with a second tine. The first tine is configured to rotate around a first axis of rotation relative to the second tine between a first position and a second position. The second tine is configured to rotate around a second axis of rotation relative to the first tine between an open position and a closed position. A force limiting device, which may be a force limiting cylinder, is operatively combined with the first tine. The force limiting device includes a piston assembly and a fluid circuit. The fluid circuit is configured to selectively allow a fluid to flow in a first direction through a relief valve for moving the force limiting device to a tripped position and in a second direction through a check valve for returning the force limiting device to an operational position. The force limiting device is biased in the operational position. Movement of the force limiting device from the operational position to the tripped position causes the first tine to rotate about the first axis of rotation from the first position to the second position.

Another aspect of the present disclosure relates to a grapple assembly configured to be combined with a prime mover vehicle having a hydraulic system and at least one arm. The grapple assembly may be a powered grapple or a mechanical grapple. The grapple assembly has a first tine and a second tine, the tines are configured to move relative to each other between an open position and a closed position for selectively grasping loads, such as trees or brush. The first tine may be an upper tine and the second tine may be a lower tine. The first tine is configured to be combined with the prime mover vehicle by a coupler or any other suitable means. The first and second tines include a forward portion, which may be a forward end, having one or more grasping teeth configured to help grasp and secure the load. Opposite the forward portion, the first and second tines include a rearward portion, which may be a rearward end. The first tine is operatively combined with the second tine. In some embodiments the first tine is combined directly with the second tine and in other embodiments the first tine and the second tine are combined indirectly through one or more intermediate members. The first tine is configured to rotate around a first axis of rotation relative to the second tine between a first position and a second position to help relieve potentially damaging levels of system pressure. The first tine is held or biased in the first position by a force limiting device during normal operation. The first tine is also configured to rotate around a second axis of rotation relative to the second tine for moving the tines between the open position and the closed position during normal operation. The force limiting device comprises a piston assembly movable between an operational position and a tripped position, and is biased in the operational position, which may be an extended position. The force limiting device is combined with the first tine so movement of the piston assembly from the operational position to the tripped position causes the first tine to rotate about the first axis of rotation from the first position to the second position. The force limiting device includes or is fluidly in communication with a self-contained fluid circuit configured to allow the flow of fluid in a first direction through a first fluid pathway for moving the piston assembly to the tripped position and in a second direction through a second fluid pathway for moving the piston assembly back to the operational position. The fluid circuit has a pressure relief valve which only opens to allow fluid to flow in the first direction through the first fluid pathway when fluid pressure on the relief valve reaches a predetermined maximum amount. In use, a closing force acts on the first tine when the first tine is closed against the load or other object. The closing force is transferred to the force limiting device and creates pressure within the device. When the closing force on the first tine is large enough to create the predetermined amount of opening pressure within the device, then the pressure relief valve opens allowing fluid to flow in the first direction through the first fluid pathway to move the piston assembly from the operational position to the tripped position. Movement of the piston assembly to the tripped position causes the first tine to rotate around the first axis of rotation in a first direction generally upward and/or backward away from the second tine thereby limiting the force transferred to the prime mover arms. A biasing member, such as a spring, is configured to move the piston assembly back to the operational position when the predetermined amount of force is no longer present, thereby causing the first tine to rotate around the first axis of rotation back to the first position. The fluid circuit is configured to allow fluid to travel in the second direction without passing through the relief valve, so the biasing force provided by the biasing member can be much lower than the predetermined amount of force required to open the relief valve and move the piston to the tripped position.

Another aspect of the disclosure relates to a method of using the grapple assembly described above to help limit the hydraulic pressure and protect the arm of the prime mover. The method includes attaching the grapple assembly to the arms of the prime mover or to a coupler secured to arms of the prime mover. Positioning the grapple assembly around a load so the first tine is positioned on one side of the load and the second tine is positioned on another side of the load. Closing the tines from the open position toward the closed position. As the tines are moving to the closed position, the hydraulic system exerts a closing force on the tines. The closing force increases as the resistance between the tines increases, such as when the load cannot be compressed any further between the tines. If the closing force on the first tine creates pressure within the force limiting device that has reached the predetermined amount of pressure required to open the relief valve, then the relief valve opens allowing the first tine to rotate around the first axis of rotation toward the second position. After the predetermined amount of force is no longer acting on the first tine, the biasing member returns the piston assembly to the operational position as fluid flows in the second direction through the second fluid flow path, thereby causing the first tine to rotate around the first axis of rotation back to the first position.

### BRIEF DESCRIPTION OF THE DRAWINGS

FIG. 1 is a side view of a grapple attachment combined with a prime mover vehicle.

FIG. 2 is a front perspective view of the mechanical grapple attachment.

FIG. 3 is a perspective view of the force limiting device.

FIG. 4 is a section view of the force limiting device with the piston assembly in the tripped position.

FIG. 5 is a section view of the force limiting device with the piston assembly in the operational position.

FIG. 6 is a schematic of the fluid circuit of the force limiting device.

FIG. 7 is a side view of the grapple attachment with the tines in the open position and the piston assembly of the force limiting device in the operational position.

FIG. 8 is a side view of the grapple attachment with the tines in the closed position and the piston assembly of the force limiting device beginning to move toward the tripped position.

FIG. 9 is a side view of the grapple attachment with the tines in a closed position as the piston assembly of the force limiting device in the tripped position.

### DETAILED DESCRIPTION

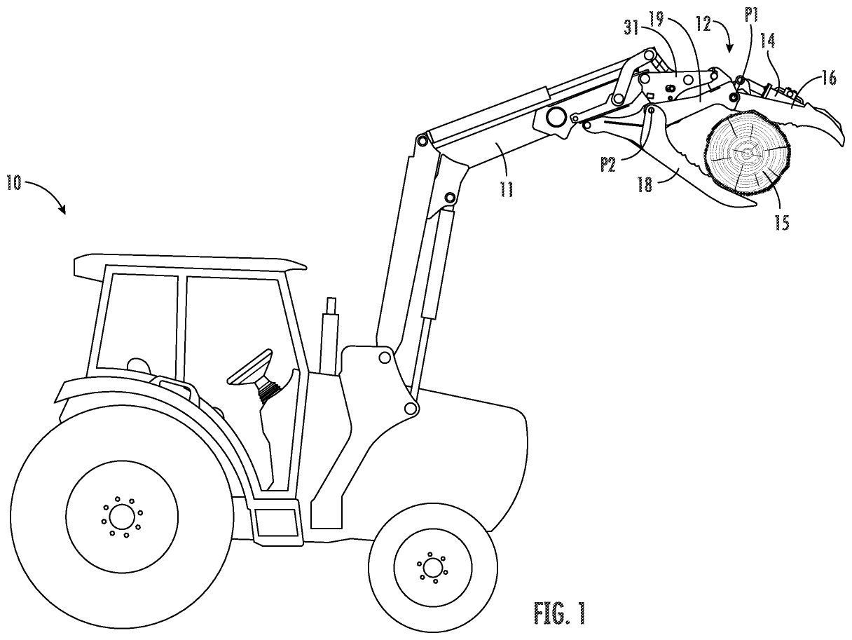

FIG. 1 generally shows a grapple assembly 12 combined with a prime mover vehicle 10. The grapple assembly 12 may be a powered grapple or a mechanical grapple. The prime mover vehicle 10 has one or more arms 11 which may be attached to a coupler 31 at one end. The arms 11 are powered by hydraulic cylinders, electric motors, or any other suitable means and are capable of lifting and tilting. The grapple assembly 12 is configured to be removably attached to the arms 11 by the coupler 31 or any other suitable means thereby allowing the arms 11 of the prime mover 10 to lift and tilt the grapple assembly 12.

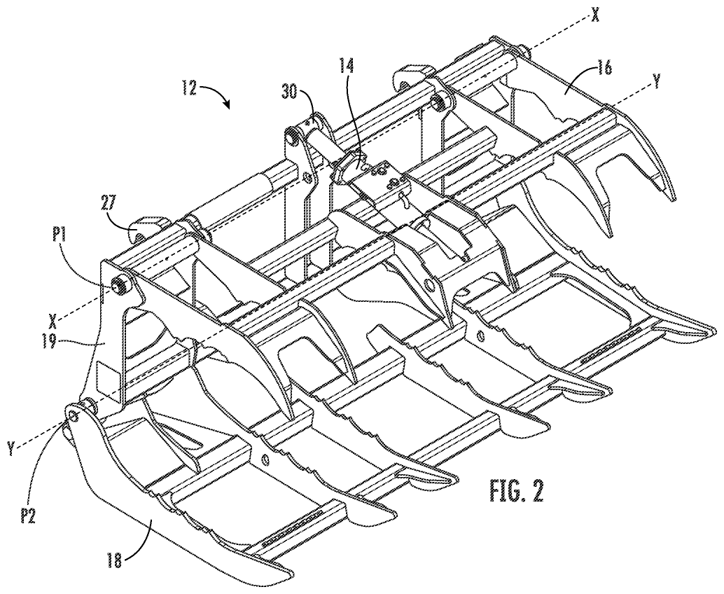

FIG. 2 show one embodiment of the grapple assembly 12. The embodiment shown in the figures is a mechanical grapple, however, powered grapples are also within the scope of this disclosure. The grapple assembly 12 comprises a first tine 16 and a second tine 18. The first tine 16 may be an upper tine and the second tine 18 may be a lower tine. It is to be understood, however, that the terms “upper” and “lower” are merely with respect to the orientations shown in the figures. Either of the first tine 16 and the second tine 18 may be above or below the other. Indeed, the first and second tines 16, 18 may be oriented such that they open in non-vertical orientations, such that neither tine 16, 18 is above or below the other. The first and second tines 16, 18 include a forward portion, which may be a forward end, having one or more grasping teeth configured to help grasp and secure the load 15. Opposite the forward portion, the first and second tines 16, 18 include a rearward portion, which may be a rearward end.

The first tine 16 and the second tine 18 are configured to move relative to each other between an open position and a closed position for grasping loads 15, such as trees or brush. The first tine 16 is operatively combined with the second tine 18. In some embodiments the first tine 16 is combined directly with the second tine 18. In other embodiments, like the embodiment shown in FIGS. 1-2 and 7-9, the first tine 16 and the second tine 18 are combined indirectly through an intermediate member 19. In the embodiment shown, the intermediate member 19 includes a mounting mechanism 27 configured to be removably attached to the prime mover 10 via a coupler 31 or other suitable means. The first tine 16 is pivotally combined with the intermediate member 19 at a first point P1 defining a first axis of rotation X. The second tine 18 is pivotally combined with the intermediate member 19 at a second point P2 defining a second axis of rotation Y. The first tine 16 is configured to rotate relative to the second tine 18 about the first axis of rotation X between a first position and a second position to help relieve potentially damaging levels of system pressure, as described below in more detail. The first tine 16 is configured to rotate relative to the second tine 18 about the second axis of rotation Y for opening and closing the tines 16, 18 during normal operation. In the embodiment shown, the first tine 16 and the intermediate member 19 rotate around the second axis of rotation Y relative to the second tine 18 during normal opening and closing of the tines 16, 18 around a load 15, while only the first tine 16 rotates around the first axis of rotation X relative to the second tine 18 and the intermediate member 19 when the force limiting device 14 is actuated to protect against potentially damaging levels of system pressure. It should be noted that in operation the distance between the tines 16, 18 may not change as the first tine 16 rotates around the first axis of rotation X since the tines 16, 18 remain closed tightly around the load and second tine 18 may pivot toward the first tines 16 at the same rate the first tine 16 is moving upward/backward relative to the intermediate member 19.

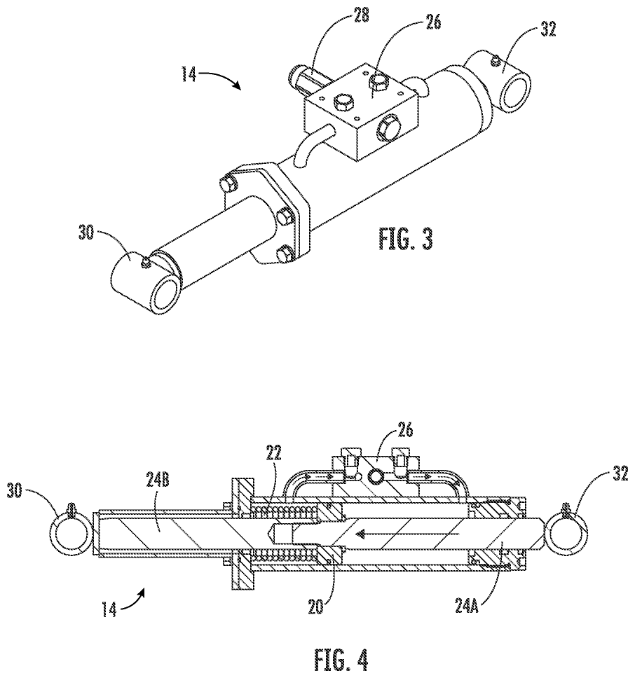

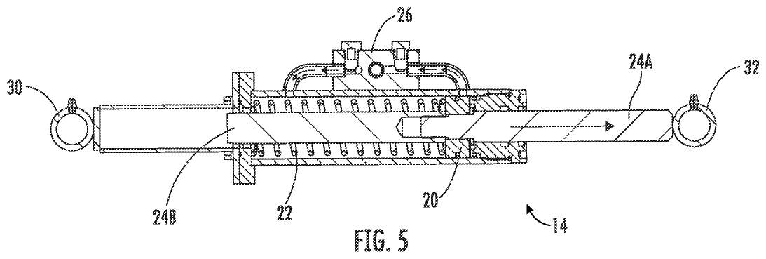

As shown in FIGS. 2 and 3, the grapple assembly 12 further comprises a force limiting device 14, which may be a force limiting cylinder, to hold or bias the first tine 16 in the first position during normal grasping operations. The force limiting device 14 has a first portion 32 combined with the first tine 16 and a second portion 30 combined with the intermediate member 19. It should be noted that either portion 30, 32 of the force limiting device 14 may be combined with either of the first tine 16 and intermediate member 19. The force limiting device 14 is movable between a tripped position (FIG. 4) and an operational position (FIG. 5). The force limiting device 14 is biased in the operational position in which the device 14 is extended by a biasing member 22, such as a spring. In other embodiments the force limiting device 14 may be biased in the operational position wherein the device 14 is retracted. Movement of the force limiting device 14 from the operational position to the tripped position causes movement of the first tine 16 from the first position to the second position.

FIGS. 4 and 5 show section views of the force limiting device 14. The force limiting device 14 includes a piston assembly having a piston 20 with a first rod portion 24A on one side of the piston 20 and a second rod portion 24B on another side of the piston 20. The piston assembly is a portion of the force limiting device 14 that moves between the operational and tripped positions. The first rod portion 24A extends outside the housing of the force limiting device 14 and is combined with either the first tine 16 or the intermediate member 19 at the first portion 32 so movement of the piston assembly from the operational position to the tripped position causes the first tine 16 to rotate about the first axis of rotation X from the first position to the second position. The second rod portion 24B takes up a volume inside the device to balance the displaced volume of the first rod portion 24A. This ensures the displaced volume of fluid is the same for both sides of the piston 20.

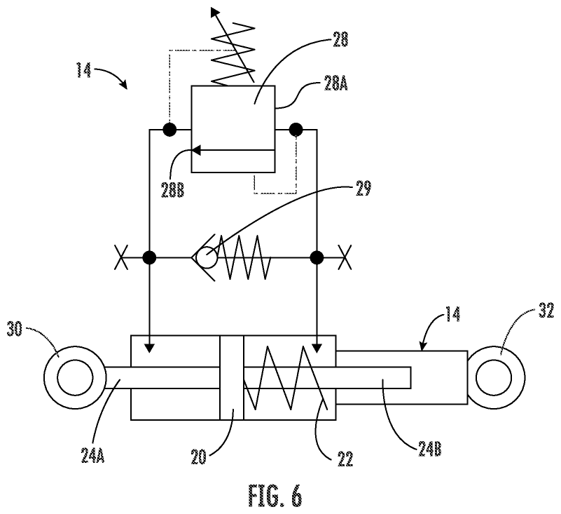

The force limiting device 14 includes or is in fluid communication with a closed or self-contained fluid circuit which may use pneumatic fluid or hydraulic fluid to move the piston assembly through the barrel of the force limiting device 14. The self-contained nature of the fluid circuit means it is not connected to any external hydraulic systems or motors. An embodiment of the fluid circuit is shown in FIG. 6. The fluid circuit includes a block 26 and a relief valve 28. The block 26 includes several pathways for the fluid to move from one side of the piston 20 to the other. FIG. 4 is a section view showing the piston assembly in the tripped position wherein fluid has traveled from one side of the piston 20 to the other in a first direction through a first fluid pathway as indicated by the arrows in the block 26. FIG. 5 is a section view showing the piston assembly in the operational position wherein fluid has traveled from one side of the piston 20 to the other in a second direction through a second fluid pathway as indicated by the arrows in the block 26. As used herein, fluid traveling in the first direction generally refers to fluid moving from one side of the piston 20 to the other for moving the piston assembly toward the tripped position. Conversely, fluid traveling in the second direction generally refers to fluid moving from one side of the piston 20 to the other for moving the piston assembly toward the operational position.

As noted above, the fluid circuit is configured to allow the flow of fluid in the first direction through the first fluid pathway for moving the piston assembly toward the tripped position and in the second direction through the second fluid pathway for moving the piston assembly toward the operational position. The fluid circuit has a pressure relief valve 28 positioned along the first fluid pathway. The relief valve 28 has an open position, a closed position, a fluid entrance side 28A, and a fluid exit side 28B. The fluid entrance side 28A is on the upstream side of the relief valve 28 and the exit side 28B is on the downstream side of the relief valve 28. In the open position the relief valve 28 allows fluid to flow in the first direction through the first fluid pathway and in the closed position the relief valve 28 prevents fluid from flowing in the first direction through the first fluid pathway. The relief valve 28 only opens when fluid pressure on the entrance side 28A reaches a predetermined maximum amount. In some embodiments the pressure relief valve 28 may be adjustable to increase or decrease the amount of opening pressure required to move the relief valve 28 to the open position. A check valve 29 positioned along the second fluid pathway allows fluid to flow in the second direction along the second fluid pathway, but prevents fluid from flowing in the first direction through the second fluid pathway. In other words, any fluid moving in the first direction must pass through the relief valve 28 in the first fluid pathway because the check valve 29 prevents any fluid from moving in the first direction through the second fluid pathway. Fluid moving in the second direction will always pass through the check valve 29 in the second fluid pathway instead of the relief valve 28 because of the relatively low amount of pressure required to unseat the check valve 29. The check valve 29 opens when a relatively minimal amount of fluid pressure is applied on the upstream side of the second fluid pathway, but remains closed when any amount of pressure is applied on the downstream side of the second fluid pathway (which is also the upstream side of the first fluid pathway). The relief valve 28 provides a predetermined amount of resistance to fluid trying to move in the first direction through the first fluid pathway. When the predetermined amount of pressure is reached on the entrance side 28A of the relief valve 28 in the first fluid flow pathway, the relief valve 28 opens and allows fluid to pass through to the other side of the piston 20, which moves the piston assembly toward the tripped position and the first tine 16 to the second position. This relieves pressure in the device 14 and limits the closing force acting on the tines 16, 18.

A biasing member 22, such as a spring, is configured to move the piston assembly back to the operational position when the predetermined amount of force is no longer present, thereby causing the first tine 16 to rotate around the first axis of rotation X back to the first position. The fluid circuit is configured to allow fluid to travel in the second direction through the check valve 29 in the second fluid pathway without passing through the relief valve 28. The force needed to unseat the check valve 29 is less than the force provided by the biasing member 22, so the biasing member 22 pushes the fluid through the circuit in the second direction. The relatively low amount of force necessary to unseat the check valve 29 means the biasing force provided by the biasing member 22 can be much lower than the predetermined amount of force required to open the relief valve 28. Therefore, resetting the device 14 to the operational position can be done with a biasing member 22 that is a spring coiled around the second rod 24B inside the force limiting device 14, as shown.

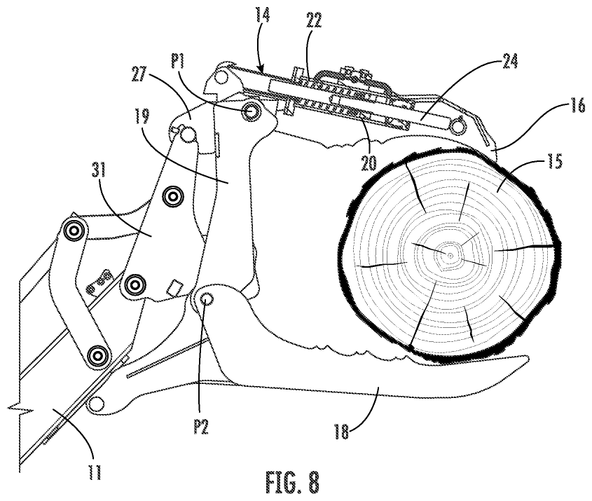

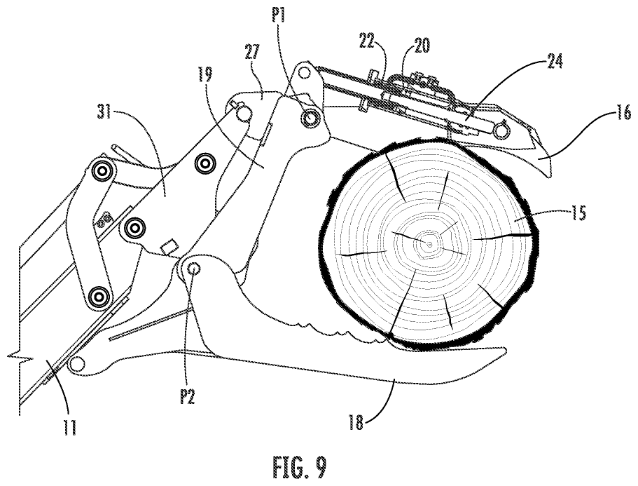

During normal operation, when the tines 16, 18 are moved between their open and closed position about the second axis of rotation Y to grasp and release a load 15, the force limiting device 14 remains in the operational position. In other words, the force limiting device 14 is not used to help grasp and release loads 15. Instead, the powered grapple or mechanical grapple assemblies are used for that purpose. The force limiting device 14 is configured to help protect the arm 11 of the prime mover 10 from seeing too much pressure. In the event the closing force used to move the tines 16, 18 toward the closed position against a load 15 reaches a predetermined level, then the force limiting device 14 trips (the relief valve 28 opens allowing movement of the piston assembly from the operational position toward the tripped position) and allows the first tine 16 to rotate around the first axis of rotation X relative to the intermediate member 19. The angle between the first tine 16 and the intermediate member 19 increases as the first tine 16 rotates generally upward and rearward around the first pivot axis X. This is shown by comparing the position of the first tine 16 relative to the intermediate member 19 in FIGS. 8 and 9. In some cases this movement also increases the distance between the first tine 16 and the second tine 18. However, in other cases the distance between the tines 16, 18 does not increase, even though hydraulic pressure in the force limiting device 14 is being relieved and the first tine 16 is rotating relative to the intermediate member 19. This is because the second tine 18 may continue to rotate toward the first tine 16 around the second axis Y as a result of the continued application of the closing force at the same rate that the first tine 16 is rotating away from the second tine 18 around axis X. It should be noted that it is not necessary for the piston assembly to move all the way to its fully tripped position in order to relieve pressure. In some instances, partial movement of the piston assembly toward the tripped position relieves sufficient force on the system.

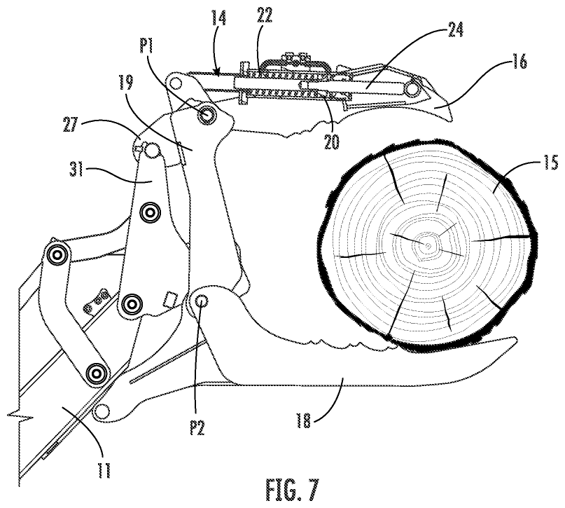

FIGS. 7-9 show the tines 16, 18 at different stages of grasping a load 15. As shown in FIG. 7, the tines 16, 18 are in the open position and there is no closing force on either of the tines 16, 18. The tines 16, 18 rotate toward each other around the second axis of rotation Y to move the tines 16, 18 from the open position toward the closed position. FIG. 8 shows the tines 16, 18 closed around the load 15. The closing force provided by the hydraulic system of the prime mover acts on the first tine 16 as the first tine 16 closes against the load 15 or other object. The closing force on the first tine 16 is generally in the direction of the second tine 18 as the tines 16, 18 are forced toward each other. As the hydraulic system continues to apply the closing force on the tines 16, 18, the closing force is transferred to the force limiting device 14, which causes pressure to build in the first fluid pathway on the entrance side 28A of the relief valve 28. FIG. 8 shows the relief valve 28 has met or exceeded the predetermined amount of opening pressure required to open the relief valve 28 as the piston assembly begins to move toward the tripped position. Fluid is flowing in the first direction through the first fluid pathway moving the piston assembly toward the tripped position. Movement of the piston toward the tripped position causes the first tine 16 to rotate around the first axis of rotation X. As shown in FIG. 9, the piston has moved to the fully tripped position.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A grapple assembly for grasping a load, the grapple assembly configured to be combined with a prime mover vehicle, said grapple assembly comprising:
a first tine operatively combined with a second tine;
wherein the first tine is configured to rotate around a first axis of rotation relative to the second tine between a first position and a second position;
wherein the second tine is configured to rotate around a second axis of rotation relative to the first tine between an open position and a closed position; and
a force limiting device having a first portion operatively combined with the first tine, the force limiting device having a relief valve configured to selectively allow movement of the force limiting device from an operational position to a tripped position;
wherein the force limiting device is configured to allow movement of the first tine from the first position to the second position when the force limiting device moves from the operational position to the tripped position.

2. The grapple assembly of claim 1 wherein the relief valve has an open position and a closed position and is biased in the closed position, the relief valve configured to move from the closed position to the open position when a predetermined amount of pressure is applied to the force limiting device.

3. The grapple assembly of claim 1 further comprising an intermediate member, the first tine is pivotally combined with the intermediate member at a first point defining the first axis of rotation, the second tine is pivotally combined with the intermediate member at a second point defining the second axis of rotation, wherein the force limiting device has a second portion operatively combined with the intermediate member.

4. The grapple assembly of claim 1 further comprising a biasing member configured to bias the force limiting device in the operational position.

5. The grapple assembly of claim 4 wherein the force limiting device further comprises a piston assembly having a piston, a first rod portion on one side of the piston, and a second rod portion on another side of the piston, and wherein the biasing member is a spring positioned around the second rod portion.

6. The grapple assembly of claim 3 wherein there is a first angle between the first tine and the intermediate member in the first position and a second angle between the first tine and the intermediate member in the second position, and the second angle is greater than the first angle.

7. The grapple assembly of claim 1 wherein there is a first distance between the first tine and the second tine in the open position and a second distance between the first tine and the second tine in the closed position, and the second distance is greater than the first distance.

8. The grapple assembly of claim 1 wherein the force limiting device further comprises a fluid circuit configured to allow fluid to flow in a first direction through a first fluid pathway for moving the force limiting device to the tripped position and in a second direction through a second fluid pathway for moving the force limiting device to the operational position, wherein the relief valve is positioned in the first fluid pathway.

9. The grapple assembly of claim 8 further comprising a check valve positioned in the second fluid pathway, the check valve having an open position wherein fluid is allowed to flow in the second direction and a closed position wherein fluid is prevented from flowing in the first direction.

10. The grapple assembly of claim 1 wherein the force limiting device is a force limiting cylinder.

11. A grapple assembly for grasping a load, the grapple assembly configured to be combined with a prime mover vehicle, said grapple assembly comprising:
a first tine operatively combined with a second tine;
wherein the first tine is configured to rotate around a first axis of rotation relative to the second tine between a first position and a second position;
wherein the second tine is configured to rotate around a second axis of rotation relative to the first tine between an open position and a closed position;
a force limiting cylinder having a first portion operatively combined with the first tine, the force limiting cylinder having a piston assembly and a fluid circuit, the piston assembly movable between an operational position and a tripped position and being biased in the operational position by a biasing member, wherein the force limiting cylinder is configured to allow movement of the first tine about the first axis of rotation from the first position to the second position when the piston assembly moves from the operational position to the tripped position;
wherein the fluid circuit is configured to allow fluid to flow in a first direction through a first fluid pathway for moving the piston assembly to the tripped position and in a second direction through a second fluid pathway for moving the piston assembly to the operational position; and
a relief valve positioned in the first fluid pathway and configured to move from a closed position to an open position to allow fluid to flow in the first direction through the first fluid pathway when pressure on the relief valve is equal to or greater than an opening pressure of the relief valve, the pressure relief valve being biased in the closed position.

12. The grapple assembly of claim 11 further comprising an intermediate member, the first tine is pivotally combined with the intermediate member at a first point defining the first axis of rotation, the second tine is pivotally combined with the intermediate member at a second point defining the second axis of rotation wherein the force limiting cylinder has a second portion operatively combined with the intermediate member.

13. The grapple assembly of claim 11 wherein the biasing member is configured to move the piston assembly from the tripped position to the operational position.

14. The grapple assembly of claim 13 wherein the piston assembly includes a piston, a first rod portion on one side of the piston, and a second rod portion on another side of the piston, and wherein the biasing member is a spring positioned around the second rod portion.

15. The grapple assembly of claim 12 wherein there is a first angle between the first tine and the intermediate member in the first position and a second angle between the first tine and the intermediate member in the second position, and the second angle is greater than the first angle.

16. The grapple assembly of claim 10 wherein the fluid circuit is self-contained.

17. The grapple assembly of claim 11 further comprising a check valve positioned in the second fluid pathway, the check valve having an open position wherein fluid is allowed to flow in the second direction along the second fluid pathway and a closed position wherein fluid is prevented from flowing in the first direction through the second fluid pathway.

18. A grapple assembly for grasping a load, the grapple assembly configured to be combined with a prime mover vehicle, said grapple assembly comprising:
an intermediate member operatively connecting a first tine and a second tine, wherein the first tine is pivotally combined with the intermediate member at a first point defining a first axis of rotation and the second tine is pivotally combined with the intermediate member at a second point defining a second axis of rotation;
wherein the first tine is configured to rotate between a first position and a second position around the first axis of rotation relative to the second tine and the intermediate member;
wherein the second tine is configured to rotate between an open position and a closed position around the second axis of rotation relative to the first tine and the intermediate member; and
a force limiting cylinder having a first portion combined with the first tine and a second portion combined with the intermediate member, the force limiting cylinder comprising:
a piston assembly movable between an operational position and a tripped position and being biased in the operational position by a biasing member;
a self-contained fluid circuit configured to allow a fluid to flow in a first direction through a first fluid pathway for moving the piston assembly to the tripped position and a second direction through a second fluid pathway for moving the piston assembly to the operational position;
a pressure relief valve positioned in the first fluid pathway and having an open position and a closed position, the pressure relief valve being biased in the closed position and moving to the open position to allow fluid to flow in the first direction through the first fluid pathway upon receiving a pressure in the first fluid pathway that is equal to or greater than an opening pressure of the relief valve.

19. The grapple assembly of claim 18 wherein movement of the piston assembly from the operational position to the tripped position allows the first tine to rotate about the first axis of rotation from the first position to the second position.

20. The grapple assembly of claim 18 further comprising a check valve positioned in the second fluid pathway configured to allow the fluid to flow through the second fluid pathway in the second direction, but preventing fluid from flowing through the second fluid pathway in the first direction.

21. The grapple assembly of claim 18 wherein the piston assembly includes a piston, a first rod portion on one side of the piston, and a second rod portion on another side of the piston, and wherein the biasing member is a spring positioned around the second rod portion.
